(19) United States
(12) Patent Application Publication
(10) Pub. No.: US 2025/0280243 A1
(43) Pub. Date: Sep. 4, 2025

(54) SPEAKER

(71) Applicant: JVCKENWOOD Corporation, Yokohama-shi (JP)

(72) Inventor: Satoshi TOMIZAWA, Yokohama-shi (JP)

(21) Appl. No.: 19/025,656

(22) Filed: Jan. 16, 2025

(30) Foreign Application Priority Data
Feb. 29, 2024 (JP) 2024-030587

(51) Int. Cl. H04R 9/06

(52) U.S. Cl. CPC H04R 9/06

(57) ABSTRACT

Provided is a speaker capable of presuming a cause of failure. A magnet, a vibrator, a voice coil configured to vibrate the vibrator, and a detector insulated from the voice coil and including a closed circuit of a conductor that is fused under a predetermined fusion condition, and the detector is disposed at a position where power is generated due to fluctuation in a magnetic field generated by the voice coil.

### CROSS REFERENCE TO RELATED APPLICATION

This application is based upon and claims the benefit of priority from Japanese patent application No. 2024-030587, filed on Feb. 29, 2024, the disclosure of which is incorporated herein in its entirety by reference.

### BACKGROUND

The present disclosure relates to a speaker.

A voice coil in a speaker generates heat or could be burnt when an excessive current is input to the voice coil.

Patent Literature 1 describes a speaker in which a drive current is made to flow through a voice coil via a fuse.

Further, Patent Literature 2 describes a speaker in which a breaker or a fuse is connected to a coil.

Patent Literature 1 Japanese Unexamined Patent Application Publication No. 2004-320264

Patent Literature 2 Japanese Unexamined Patent Application Publication 2008-259247

However, there has been a problem in that when a voice coil of a speaker fails by a burnout, it is impossible to identify and presume whether the cause of the burnout is an excessive input or a factor other than the excessive input. Further, in the speakers of Patent Literature 1 and Patent Literature 2, there has been a problem in that when a fuse blows, the speaker itself can no longer function, and thus, the cause of failure of the speaker is difficult to identify.

### SUMMARY

A speaker of one embodiment includes: a magnet; a vibrator; a voice coil configured to vibrate the vibrator; and at least one detector insulated from the voice coil and including a closed circuit of a conductor that is fused under a predetermined fusion condition, in which the at least one detector is disposed at a position where power is generated due to a fluctuation in a magnetic field generated by the voice coil.

### BRIEF DESCRIPTION OF THE DRAWINGS

The above and other aspects, advantages and features will be more apparent from the following description of certain embodiments taken in conjunction with the accompanying drawings, in which:

FIG. 1 is a cross-sectional view showing a schematic configuration of a speaker according to Embodiment 1;

FIG. 2 is a perspective view showing the schematic configuration of the speaker according to Embodiment 1; and

FIG. 3 is a perspective view showing the schematic configuration of the speaker according to Embodiment 1.

### DETAILED DESCRIPTION

For clear explanation, the following descriptions and drawings are omitted and simplified, as appropriate. In the drawings, the same elements are assigned the same reference signs, and overlapping descriptions are omitted, as necessary. Further, for clear explanation, the descriptions will be made using an XYZ three-dimensional orthogonal coordinate system. Relative to a speaker 100, a front-rear direction (depth direction), a left-right direction (horizontal direction), and an up-down direction (vertical direction) are referred to as a Z-direction, an X-direction, and a Y-direction, respectively. A front direction, a rear direction, a right direction, a left direction, an upward direction, and a downward direction are referred to as a +Z-direction, a −Z-direction, a +X-direction, a −X-direction, a +Y-direction, and a −Y-direction, respectively.

### Embodiment 1

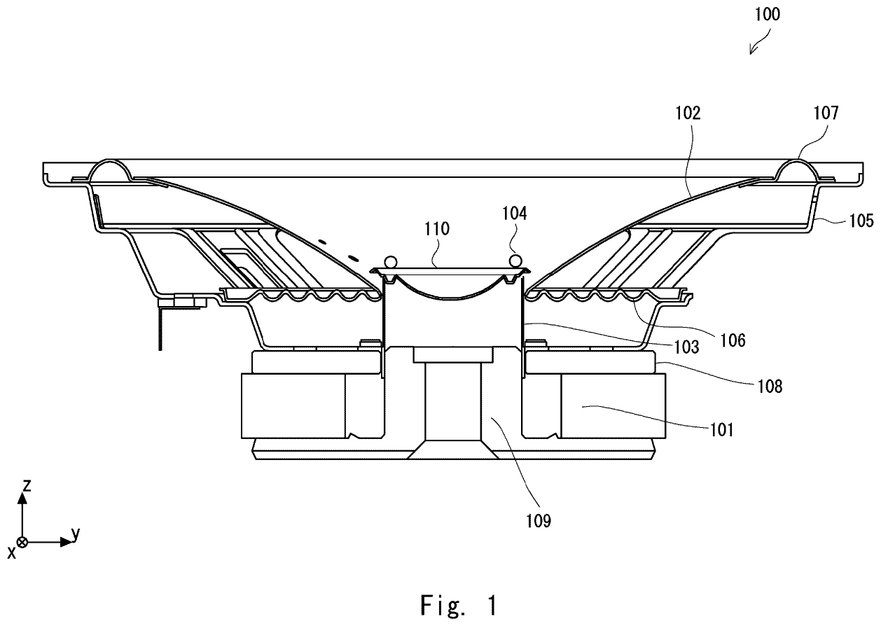

Hereinafter, with reference to the drawings, an embodiment of the present disclosure will be described. FIG. 1 is a cross-sectional view showing a schematic configuration of a speaker according to Embodiment 1. In FIG. 1, the speaker 100 includes a magnet 101, a vibrator 102, a voice coil 103, a detector 104, a frame 105, a dumper 106, an edge 107, a plate 108, a yoke 109, and a cap 110.

The magnet 101 is, for example, a permanent magnet.

The vibrator 102 is physically connected to the voice coil 103. Due to the vibration of the vibrator 102, air vibration (compressional wave) is generated. For example, the vibrator 102 has a ring shape. Further, a cross-sectional shape of the vibrator 102 may be in any shape, and may be in a curved shape as shown in FIG. 1. Furthermore, the vibrator 102 is preferably composed of a synthetic resin, paper, cloth, or the like.

The magnet 101 forms a magnetic field closed circuit through interaction between the magnet 101 and iron materials such as the plate 108 and the yoke 109. The voice coil 103 vibrates in the front-rear direction (Z-direction) of the speaker 100 upon receipt of an electromagnetic force from a magnetic field formed in a gap around the magnetic field closed circuit, in response to change with time in the current of an electric signal applied to the voice coil 103. The vibrator 102 also vibrates in the front-rear direction (Z-direction) of the speaker 100 due to the vibration of the voice coil 103. The speaker 100 can emit sound due to this vibration.

The detector 104 includes a closed circuit of a conductor that is fused under a predetermined condition. In the following descriptions, the condition under which the detector 104 is fused may be referred to as a fusion condition. The detector 104 is, for example, a conductor formed in a doughnut shape. The detector 104 may be a conductor with a coil wound in a helix or a spiral shape a plurality of turns, as long as it is a closed circuit with a start point and an end point connected. Here, the detector 104 is preferably formed in a round shape, but not limited thereto, and may be in an elliptic or a quadrangular shape. The detector 104 is insulated from the voice coil 103. The detector 104 is fixed at a position where power is generated due to fluctuation in the magnetic field generated by power applied to the voice coil 103. The detailed principle of detection by the detector 104 will be described later.

For example, the detector 104 is disposed such that a center axis of the voice coil 103 is located on an inner side the closed circuit of the detector 104. More specifically, the detector 104 is preferably disposed such that the center axis of the voice coil 103 is located near a center axis of the detector 104. Here, the center axis of the detector 104 is a center axis of the speaker 100, and the center axis of the voice coil 103 is a center axis of a loop formed by a winding of the closed circuit of the detector 104.

For example, the detector 104 is disposed such that an angle of a plane in which the voice coil 103 is wound and an angle of a plane formed by the winding of the closed circuit of the detector 104 are coincide with or proximate to each other. In other words, the plane on which the voice coil 103 winds and the plane formed by the closed circuit winding of the detector 104 are approximately parallel. For example, as in FIG. 1, when the plane in which the voice coil 103 is wound is an XY-plane, the plane formed by the closed circuit of the detector 104 is also the XY-plane.

For example, the detector 104 may be fixed on an exterior surface of the speaker 100, that is, a side that is visually recognized by a user of the speaker 100. The detector 104 is fixed on the exterior surface of the speaker 100 so that it can be presumed that a failure was caused by application of an excessive power to the coil, by visual observation without disassembling the speaker. For example, the detector 104 is fixed on a surface of the cap 110 as in FIG. 1. Further, the detector 104 may be disposed on a site other than the exterior surface of the speaker 100. The detailed arrangement of the detector 104 will be described later.

The fusion condition of the detector 104 can be set in any manner in accordance with the positional relation between the detector 104 and the voice coil 103, and a thickness and a resistance value of a conductor wire of the closed circuit. The detailed fusion condition of the detector 104 will be described later. Further, the speaker 100 may include a plurality of detectors 104 having different fusion conditions.

The frame 105 is a frame that supports each component of the speaker 100.

The dumper 106 physically connects the voice coil 103 and the frame 105 and holds the voice coil 103 moving in the up-down direction (Z-direction) at an accurate position.

The edge 107 is physically connected to the vibrator 102 and the frame 105 and holds the vibrator 102 at an accurate position.

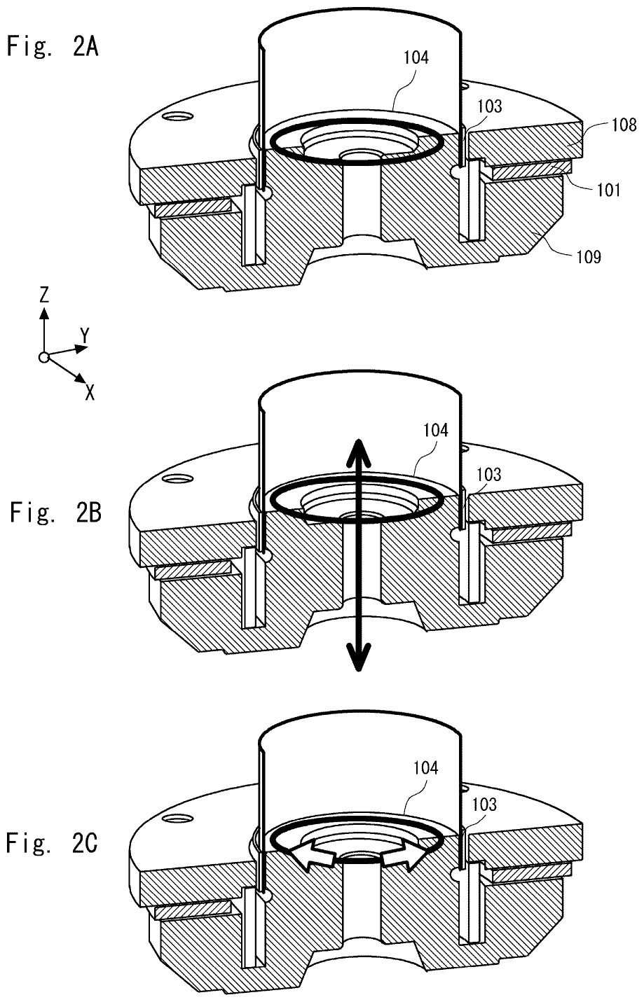

Next, the principle of the detector 104 will be described. FIG. 2 is a perspective view showing the schematic configuration of the speaker according to Embodiment 1. In this example, unlike FIG. 1 in which the detector 104 is disposed on the exterior surface of the speaker 100, as shown in FIG. 2(a), an example in which the detector 104 is disposed in an upper portion (+Z side) of the yoke 109 other than the exterior surface of the speaker 100 will be described.

When current flows to the voice coil 103, a magnetic field is generated in a direction perpendicular to the plane in which the voice coil 103 is wound. Specifically, the magnetic field is generated in the up-down direction (Z-direction) as denoted by an arrow in FIG. 2(b). The arrow in FIG. 2(b) also shows the variation of the magnetic field generated by the current flowing in the voice coil 103, and the arrow penetrates the plane formed by the closed circuit of the detector 104. In the voice coil 103, since the current changes corresponding to a sound to be generated, this magnetic field also changes.

Due to the change in the magnetic field generated by the voice coil 103, electromagnetic induction occurs in the detector 104, so that the current flows to the detector 104 as denoted by an arrow in FIG. 2(c). In other words, the current flows through the detector 104 by placing the detector 104 in a position where the variation of the magnetic field generated by the current flowing in the voice coil 103 passes through the plane formed by the closed circuit of the detector 104.

The value of the current flowing to the detector 104 fluctuates in proportion to the magnitude of the fluctuation in the generated magnetic field. Therefore, the value of the current flowing to the detector 104 (in other words, a power value to be added) is in proportion to the magnitude of an electric signal input to the voice coil 103.

The fusion condition of the detector 104 can be set based on the relation between the electric signal input to the voice coil 103 and the value of the current (or the power value) generated in the detector 104 by the electromagnetic induction. That is, it is only necessary to set the detector 104 so as to be fused at the value of the current (or the power value) generated in the detector 104 corresponding to the power value input to the voice coil 103 to be detected.

In the following description, the power value input to the voice coil 103 to be detected may be referred to as a detection power value. The detection power value may be, for example, a maximum power value that is allowed to be input to the voice coil 103. That is, the fusion condition is set to be the value of the power generated in the detector 104 corresponding to the maximum power value that is allowed to be input to the voice coil 103, so that it can be presumed that when the speaker 100 fails, in a case where the detector 104 is fused, the cause of failure is a burnout due to an excessive input, and in a case where the detector 104 is not fused, the cause of failure is another factor. The cause of failure other than the excessive input is, for example, mechanical failure.

When the speaker 100 includes a plurality of detectors 104, the detectors 104 may be set so as to be fused under different fusion conditions. For example, a case is assumed in which the fusion condition of a given detector 104 is set to be a value of the power generated in the detector 104 corresponding to a maximum power value that is allowed to be input to the voice coil 103. At this time, the fusion condition of a detector 104 different from the given detector 104 is a value of the power smaller than the fusion condition of the given detector 104. In this manner, the speaker 100 includes a plurality of detectors 104 for which different fusion conditions are respectively set, so that the maximum power value input to the voice coil 103 can be presumed in more detail.

The maximum power value input to the voice coil 103 can be presumed in more detail, so that for example, also in a case where the speaker 100 is not failed, whether the detector 104 is fused can be confirmed at the time of a vehicle inspection. If none of the plurality of detectors 104 is fused, it can be presumed that only power values lower than the detection power values corresponding to the plurality of fusion conditions are input to the voice coil 103. If one or more of the plurality of detectors 104 are fused, it can be presumed that power values corresponding to the fusion conditions of the fused detectors 104 were input to the voice coil 103. In this manner, the use condition of the speaker on the market can be identified, which can be used as a reference for design values of the allowable power for the speaker.

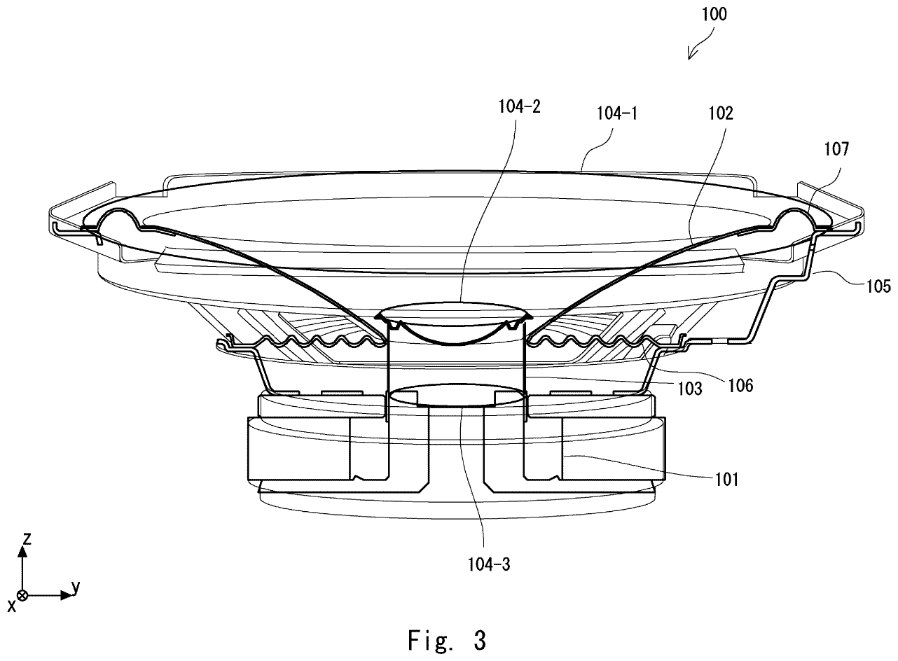

Next, the position of the detector 104 will be described. FIG. 3 is a perspective view showing the schematic configuration of the speaker according to Embodiment 1. In FIG. 3, in the speaker 100, the position where the detector 104 is disposed is 104-1, 104-2, 104-3, and the like.

The detector 104 may be disposed at a position denoted by 104-1, that is, on a surface of the edge 107 and the exterior surface of the speaker 100. When the detector 104 is disposed at the position 104-1, since it can be disposed without interfering with other components of the speaker 100, there is an advantage in that the production of the speaker 100 is less affected.

The detector 104 may be disposed at a position denoted by 104-2, that is, on the surface of the cap 110 and the exterior surface of the speaker 100. The position denoted by 104-2 is the same as the position of the detector 104 shown in FIG. 1. When the detector 104 is disposed at the position 104-2, it is disposed on an appearance surface of the speaker 100, so that it becomes easier to confirm whether the detector 104 is fused.

The detector 104 may be disposed at a position denoted by 104-3, that is, a position in a vicinity of the magnet 101 other than the exterior surface of the speaker 100. The position of the detector 104 denoted by 104-3 is, for example, the upper portion (+Z side) of the yoke 109, but the configuration is not limited thereto, and the detector 104 may be disposed in an upper portion (+Z side) of another iron material, such as the plate 108. The position denoted by 104-3 is the same as the position of the detector 104 shown in FIG. 2. When the detector 104 is disposed at the position 104-3, since the detector 104 is close to the voice coil 103, it is possible to increase the value of the power generated in the detector 104 when the same power value is input to the voice coil 103 as compared to the other positions, thereby enabling accurate detection of the value of the power to be detected having been input to the voice coil 103.

In this manner, according to the speaker of the embodiment, it is possible to presume whether a failure was caused by a burnout due to an excessive input exceeding the capacity of the voice coil 103.

Further, according to the speaker of the embodiment, it is possible to grasp the use condition of the speaker on the market by recording causes of failures.

Furthermore, according to the speaker of the embodiment, it is possible to presume whether a failure was caused by a burnout due to an excessive input, without making any changes to general production methods or structures of the speaker.

Further, according to the speaker of the embodiment, it is possible to presume whether a failure was caused by a burnout due to an excessive input, with addition of an inexpensive component.

Note that the present disclosure is not limited to the aforementioned embodiment, and can be appropriately changed within the scope without departing from the gist. For example, it is preferable that the detector 104 be disposed such that the center axis of the voice coil 103 is located on the inner side of the closed circuit of the detector 104, but the center axis of the voice coil 103 and the center axis of the detector 104 may not be coaxial with each other. The center axis of the voice coil 103 and the center axis of the detector 104 may be displaced from each other. Further, the plane in which the voice coil 103 is wound and the plane formed by the winding of the closed circuit of the detector 104 may be inclined.

Further, the detector 104 and the speaker 100 may be manufactured as separate bodies and the detector 104 may be fixed to the speaker 100 when the speaker 100 is used.

Furthermore, in the detector 104, the closed circuit may be formed by, for example, forming an appearance by deposition and a single-turn coil on a specific surface of the cap 110 of the speaker 100. A plurality of pieces of foil having different widths may be deposited on the cap of the speaker 100 so as to read the input value when the speaker 100 is damaged.

Further, the detector 104 may be attached to a sticker for a model name on a back side of the speaker 100.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A speaker comprising:
a magnet;
a vibrator;
a voice coil configured to vibrate the vibrator; and
at least one detector insulated from the voice coil and including a closed circuit of a conductor that is fused under a predetermined fusion condition,
wherein the at least one detector is disposed at a position where a fluctuating magnetic field generated due to a current flowing to the voice coil passes through a plane formed by the closed circuit of the at least one detector, so that power is generated in the at least one detector.

2. The speaker according to claim 1, wherein the at least one detector is disposed such that a center axis of the voice coil is located on an inner side of the closed circuit of the at least one detector.

3. The speaker according to claim 1, wherein the at least one detector is disposed such that an angle of a plane in which the voice coil is wound and an angle of a plane formed by the closed circuit of the at least one detector are proximate to each other.

4. The speaker according to claim 1, wherein the fusion condition is a value of power generated in the at least one detector corresponding to a maximum power value that is allowed to be input to the voice coil.

5. The speaker according to claim 1, comprising the at least one detector including a plurality of detectors, the plurality of detectors having different fusion conditions.

6. The speaker according to claim 1, wherein the at least one detector is fixed on an exterior surface of the speaker.
